(19) United States
(12) Patent Application Publication
(10) Pub. No.: US 2005/0060651 A1
(43) Pub. Date: Mar. 17, 2005

(54) Electronic document indexing system and method

(76) Inventor: Roy Edward Anderson, Wellington (NZ)

Correspondence Address: BURNS DOANE SWECKER & MATHIS L L P, POST OFFICE BOX 1404, ALEXANDRIA, VA, 22313-1404, US

(21) Appl. No.: 10/493,581

(22) PCT Filed: May 5, 2003
(86) PCT No.: PCT/NZ03/00082

(30) Foreign Application Priority Data
May 3, 2002 (NZ) 518744

(51) Int. Cl. G06F 17/00

(52) U.S. Cl. 715/530

(57) ABSTRACT

The invention provides an electronic document indexing system comprising one or more word use nodes maintained in computer memory, each word use node representing a word in an electronic document and including a location of the word in the document; and one or more node objects maintained in computer memory, the node object or objects respectively associated with one or more word use nodes. The invention further provides a related method of creating an electronic document index.

### FIELD OF INVENTION

The invention relates to an electronic document indexing system, in particular an abstract document network (ADN) of an electronic document. The invention also relates to a method of building an electronic document index and methods of searching a document using the document index.

### BACKGROUND TO INVENTION

The low cost of data storage hardware has led to the collection of large volumes of data. The world wide web, for example, is a distributed database providing access to tens of millions of different documents. Users of such networks generally need to locate and analyse specific web pages or other electronic documents containing information of interest. It is a laborious process to read and review each electronic document to extract information from the document.

### SUMMARY OF INVENTION

In broad terms in one form the invention comprises an electronic document indexing system comprising one or more word use nodes maintained in computer memory, each word use node representing a word in an electronic document and including a location of the word in the document; and one or more node objects maintained in computer memory, the node object(s) respectively associated with one or more word use nodes.

In broad terms in another form the invention comprises a method of creating an electronic document index comprising the steps of storing one or more word use nodes in computer memory, each word use node representing a word in an electronic document and indexing the location of the word in the document; and storing one or more node objects in computer memory, the node object(s) respectively associated with one or more word use nodes.

### BRIEF DESCRIPTION OF THE FIGURES

Preferred forms of the electronic document indexing system and method will now be described with reference to the accompanying figures in which:

FIG. 1 shows a block diagram of a system in which one form of the invention may be implemented;

FIG. 2 shows the preferred system architecture of hardware on which the present invention may be implemented;

FIG. 3 shows a conceptual diagram of an abstract document network;

FIG. 4 illustrates the identification of sentence and word units in a document;

FIG. 5 shows the creation of nodes and links;

FIG. 6 shows the creation of an abstract from the abstract document network;

FIG. 7 illustrates a further method associated with abstract discovery;

FIG. 8 illustrates phrase identification;

FIG. 9 shows the gathering of phrases from qualifying word uses;

FIG. 10 shows a sample document; and

FIG. 11 shows a set of nodes resulting from the source text of FIG. 10.

### DETAILED DESCRIPTION OF PREFERRED FORMS

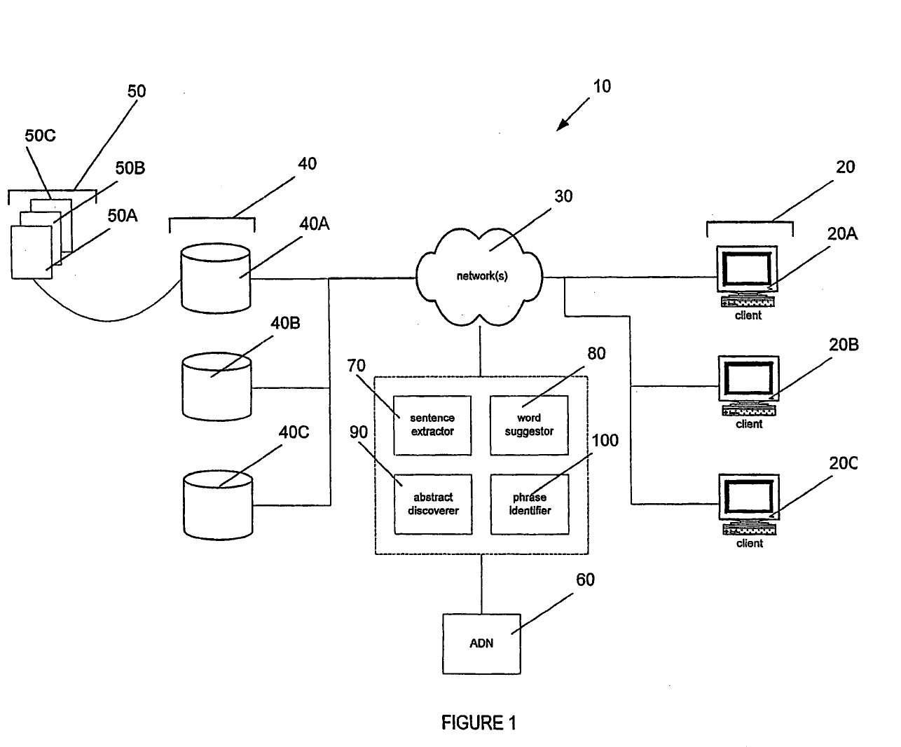

FIG. 1 illustrates a block diagram of the preferred system 10 in which one form of the present invention may be implemented. The system includes one or more clients 20, for example 20A, 20B and 20C, which each may comprise a personal computer or workstation described below. Each client is connected to a network 30 as shown. It is envisaged that network 30 could comprise a local area network or LAN, a wide area network or WAN, an Internet, Intranet or wireless access network or any combination of the foregoing.

System 10 further comprises one or more servers, for example 40A, 40B and 40C. Each server 40 is connected to network or networks 30 as shown in FIG. 1. Each server 40 could comprise a personal computer, workstation or other computing device but may also comprise several workstations connected by separate private networks.

The system 10 further comprises electronic documents 50, for example 50A, 50B and 50C maintained on a server 40. Each electronic document could comprise a web page comprising textual information, multimedia content, software programs, graphics, audio signals, videos and so on. The electronic document could further include textual information in any suitable form. Each document 50 preferably includes a unique network address, for example a URL by which the document is indexed.

The system 10 further comprises an abstract document network or ADN 60 which will be further described below. The abstract document network is built up from one or more documents 50. The system 10 may optionally further comprise a cited sentence abstractor 70, a word suggestor 80, an abstract discoverer 90 and/or a phrase identifier 100.

The ADN 60 could be stored in any suitable computer memory forming part of the system 10. The sentence abstractor 70, the word suggester 80, the abstract discoverer 90 and the phrase identifier 100 could be implemented in the form of computer software code installed and operating on any computer memory forming part of the system 10.

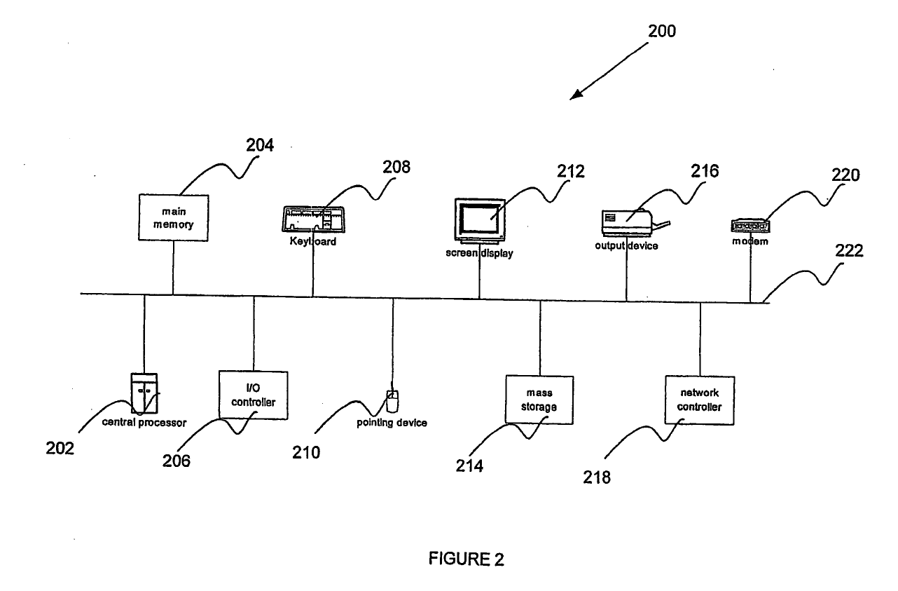

FIG. 2 shows the preferred system architecture of a client 20 or server 40. The computer system 200 typically comprises a central processor 202, a main memory 204 for example RAM, and an input/output controller 206. The computer system 200 also comprises peripherals such as a keyboard 208, a pointing device 210 for example a mouse, track ball or touch pad, a display or screen device 212, a mass storage memory 214 for example a hard disk, floppy disk or optical disk, and an output device 216 for example a printer. The computer system 200 could also include a network interface card or controller 218 and/or a modem 220. The individual components of the system 200 could communicate through a system bus 222 or could be implemented as individual components on a network

It is envisaged that known equivalents could be substituted for the components of the computer system 200 described above. For example, the keyboard 208 is one form of data entry device which could be replaced or supplemented with other data entry devices, for example a touch sensitive screen or voice activated speech recognition hardware and software.

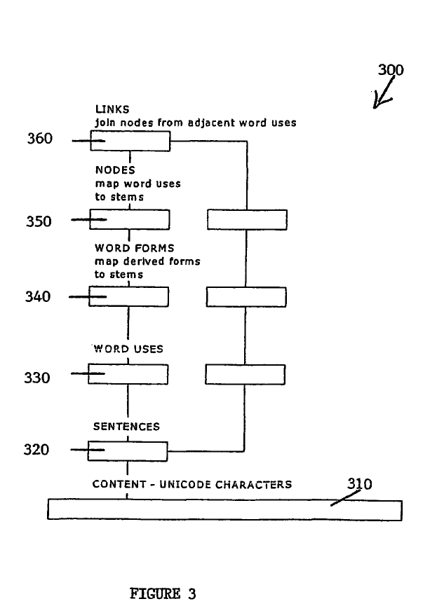

FIG. 3 shows a conceptual diagram of a preferred form abstract document network (ADN) in accordance with the invention. The ADN 300 is developed from content 310 in an electronic document. This content could include any collection of text. This text could, for example, comply with the Unicode Standard for representing multi language character sets.

The content 310 is scanned for sentence boundaries, for example using a conventional break iterator tool. In one form the break iterator could scan the content for a full stop, apostrophe or question mark signifying a sentence boundary in English for example. The resulting structure could be a set of sentence objects 320. Each sentence object represents a sentence in the content 310 and could include a reference to the URL or source text of the document, together with an offset of the first character of the sentence and an index of the first word used. The sentence object could represent, for example, a position in the content array of the sentence and a length in characters of the sentence.

The word units in the content 310 are then identified using a suitable break iterator. The resulting word use objects 330 could represent individual word units within a sentence. Each word use object represents a word in the electronic document content and includes a location of the word in the document. This location could include a character offset within a particular sentence object 320.

The word use object could also include a stem word from. For example, the word “struck” appearing in the content 310 would have a stem word form of “strike” and this stem word form would be included in the word use object 330 representing the word “strike”.

Each word use object 330 could have an associated sentence object and so the location of the word in the document could be represented as a sentence object node identifying the sentence in which the word appears together with a word offset identifying the position of the word within the sentence.

The network 300 also includes one or more word form nodes 340. Each word form node preferably represents a word in the electronic document, and could be represented as a series of word pairs. One part of the word pair represents the word exactly as it appears in the content 310. The other part of the word pair represents the stem form of the word. For example, where the word “struck” appears in the content 310, the corresponding word form node would include the word pair comprising “struck” and “strike”.

The network 300 includes one or more node objects 350 maintained in computer memory. Each node object is associated with one or more word use objects. Each node object could include, for example, a set of pointers to respective word use objects. Each node object could also include a word stem form for searching purposes. Each node object could further include a weight representing word frequency in the content 310. This weight could be represented by an integer for example, representing the number of sentences in which a particular word appears in the document.

The network 300 may include one or more link objects 360 maintained in computer memory. Each link object represents a pair of word use nodes. A pair of word use nodes could be included in a link object where the words appear in close proximity in the content 310. Where words appear in close proximity, they are said to exhibit co-occurrence.

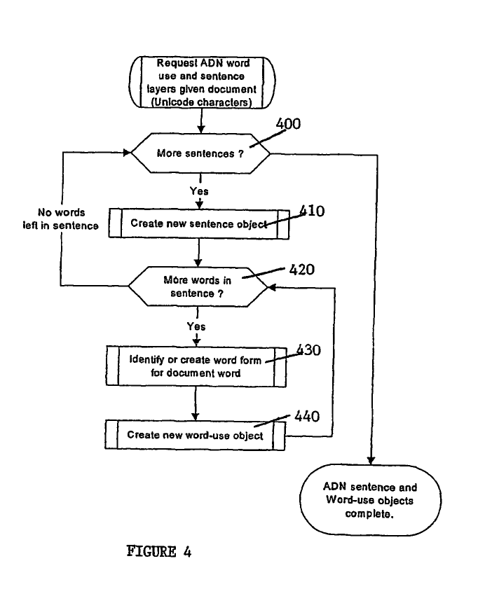

Referring to FIG. 4, an abstract document network is created by first identifying sentence and word units in the document. The boundaries of these units are defined as appropriate for a given language locale. The unit boundaries will be different for English, Portuguese and Chinese for example.

While there are more sentences left to process in the content 400, a new sentence object is created 410 for the new sentence. While there are more words in the sentence 420, a word form node is created for the new word and a new word use object is created 440.

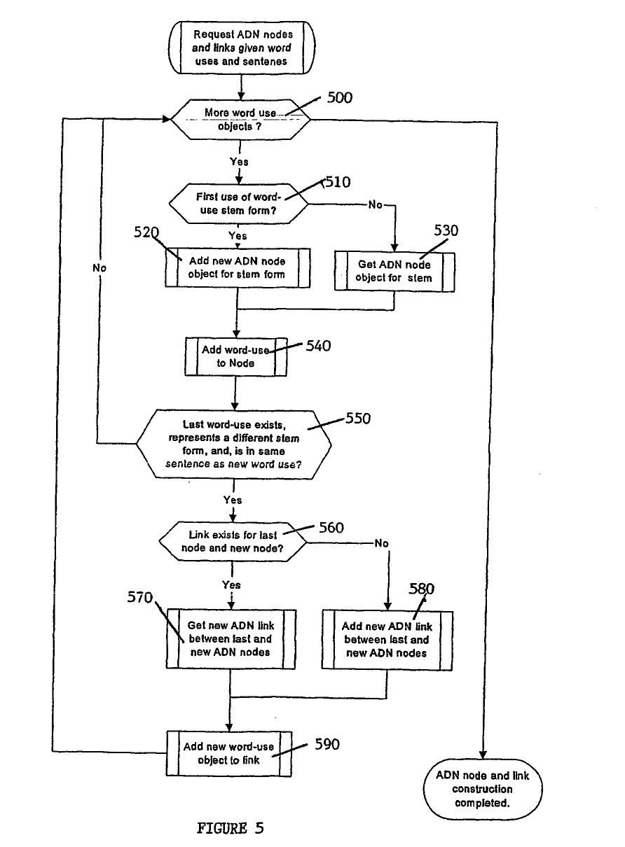

Referring to FIG. 5, once the sentence and word use objects are created, they are stored in computer memory. While there are more word use objects 500, the word use stem form is analysed to determine whether it is the first use of this stem form 510. If it is the first use of the stem form, a new node object is created for this stem form 520. On the other hand if it is not the first use of the word use stem form, then the node object for the appropriate stem form is retrieved from computer memory 530.

The word use object is added 540 to the node object.

If the last word use exists, the word use represents a different stem form, and the word use is in the same sentence as the new word use 550, then a potential link is analysed for the last node and the new node 560. If a link does exist, the new node object link between the last and the new node object is retrieved 570, otherwise a new node object link is added between the last and the new node objects 580. The new word use object is then added 590 to the link.

It is envisaged that the indexing system excludes certain words appearing in the content. These words, known as stop words, could be identified by rules including word length and/or membership of a stop word set. These stop words could include, where the content is English, prepositions, adverbs and pronouns such as “when”, “on”, “as”, “I” and “was”.

Where stop words are excluded from the document index, a link object can be used to identify all uses of a given pair of adjacent non-stop words ignoring any intervening stop words. It is envisaged that the link object could link any pair of approximate non-stop words as not limited to adjacent non-stop words.

Once the electronic document indexing system is completed, a phrase specifying a sequence of stem words, stop words or literal text can be located by identifying word uses of corresponding stem forms. These word uses can be used to compare sequences of source text words or word use objects as required for the phrase. Unless searching for a literal sequence of words, the actual text need not be referenced but if required, form or case sensitive equality of each word can be asserted over the document text.

Providing a targeted word, linked pair of words, or a phrase includes stem forms, namely non-stop words, the indexing system gives constant time access to the associated sets of word uses, independent of document length. The interrelated network layers of sentences, word use objects, nodes and links provide a basis for the efficient computation of optimally connected stem forms and identification of document phrases by providing sets of word use objects for constituent nodes in the form of stem forms and links in the form of adjacent stem forms.

The abstract document network can be used as a tool for querying the document. One function is to identify sentences that meet simple to complex lexical criteria including Boolean expressions. A typical expression could be to “find all sentences having words with the stem “weight” in combination with any of identify, count, sentence, document”.

The collation of word use objects into a set of output sentences can be achieved using cite objects, each of which collects word use objects associated with a particular sentence. The construction of cite objects can be co-ordinated through cite maps.

A cite map is generated by retrieving and organising the word uses associated with a node as a stem form or link as a co-occurrence of stem forms. A cite object is generated for each different sentence object which constitute the keys by which each cite object is identified All word use objects are collected into their sentence cite objects.

Cite maps can support the evaluation of complex criteria by combinations with Boolean operators such as “and”, “or” and “not” to produce resultant cite maps. A Boolean “and” of two or more maps produces an output cite map of only those cite objects for sentences which are present in all the input cite maps as the intersection of cites based on sentence keys.

A Boolean “or” of two or more cite maps produces an output map containing cite objects for all the sentences in cite objects in the input maps as a union of cites based on sentence keys.

For both “and” and “or” operations, the cite objects in the resultant cite map include all the word use objects from corresponding cites in the input cite maps as the union of all word use objects in corresponding input cite objects.

For a Boolean “not” operation, the cite objects in a cite map that have corresponding cite objects in the other cite maps are excluded from the resultant cite map.

In this way, word uses of a word form can be located by stemming the word, retrieving word use objects from the stem form node, and comparing the source text associated with the word use with the stemmed form. These can be collected into cite objects in a cite map. Each cite object would have one or more word uses of the target word. Likewise, adjacent uses of a pair of non-stop words would result in a cite map of zero or more cite objects in a cite map. Such cite maps could be combined using Boolean operators in an expression of two or more terms to produce a resultant cite map.

The sorted cite objects in a cite map can be used to extract corresponding sentences from the document text highlighting the words designated by the other word use objects of the cite. This requires reference to the segment of plain text associated with the sentence of the cite. If required, the segment is split along the word use boundaries of the cite and the text can be marked up to highlight the words of the cite.

In another form of the invention, a table of suggested words can be generated for refinement of a search expression from a collection of cite objects produced by the evaluation of a search expression over a given abstract document network.

The complete table of words in the cited sentences other than words in the search expression can be constructed by surveying the word uses in the sentences represented in the cite objects. The table is made to accumulate the number of cite object sentences in which each word is used. The table would therefore have an entry for every word in cited sentences each with a sentence count with respect to the cite objects.

When the search expression word forms are excluded, the remaining stem forms and sentence counts suggests words that would further narrow the search expression with precisely quantified results. In addition, the suggested words provide a profile of the content addressed by a search expression but not included in its explicit terms.

The search expression can be extended by the additional condition that sentences must include a given word in the table of suggestions. When the extended search expression is used, precisely the number of sentences accumulated in the table entry for the word are produced.

A further preferred feature of the invention is that of abstract discovery. An ADN abstract is the search expression and set of word use objects identified through an optimally related set of linked nodes all with word uses in a set of sentences of a nucleus node. The set is optimal in that it has the highest total measured sub-network weight found within the restrictions of time and number of solution sub-networks considered. A sub-network weight is the sum of the number word uses for each constituent link.

A sub-network is a descendant of a parent sub-network if it adds a single new node that is a member of a link node pair with any node in the parent sub-network that has one or more word uses in the sentences of the nucleus node.

Abstract discovery identifies a single node or multiple related nodes in an abstract document network. Discovery begins by constructing a sub-network consisting of the nucleus node alone. All possible extensions to the sub-network are proposed and considered for entry into the elite sub-networks prior to their construction. The set of elite sub-networks is limited to a certain size. This set is used to generate a new set of extended sub-networks. Generation after generation of sub-networks are created until either a limited time allowed for abstract discovery has passed or the maximum number of solutions has been considered. The optimal sub-network is then chosen from the final set of elite sub-networks as the result of the document abstraction with respect to the given nucleus.

The weight of a proposed new sub-network is computed from its parent sub-network prior to construction by adding the weight of the parent to the weight of any links with the new node to nodes already in the parent sub-network. This eliminates the cost of construction of lower weight sub-networks that would fail to qualify for entry into the elite set and reduces the cost of computing sub-network weight by reference to known sub-network links and weights.

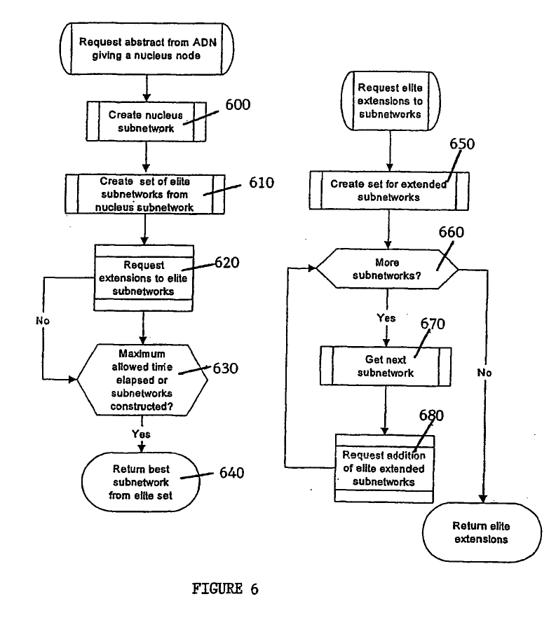

Referring to FIG. 6, the first step in requesting an abstract from an abstract document network is to create 600 a nucleus sub-network. The next step is to create 610 a set of elite sub-networks from nucleus sub-network and then to request 620 extensions to elite sub-networks. If the maximum allowed time has elapsed or sub-networks constructed 630, the best sub-network is returned 640 from the elite set.

In order to request elite extensions to sub-networks, the first step is to create 650 a set for extended sub-networks. If there are more sub-networks 660, the next sub-network is retrieved 670 and an addition of elite extended sub-networks is requested 680.

Abstract discovery always produces a result, the least being the nucleus and the word uses of the nucleus. Ideally, the abstract result is a set of related nodes and a sub-set of nucleus sentences in which significant linked words are identified. A longer maximum processing time, or greater limiting number of solutions allowed to be considered would typically result in a useful sub-set of a ADN nodes, namely non-stop words, that are highly interrelated by sentence co-occurrence.

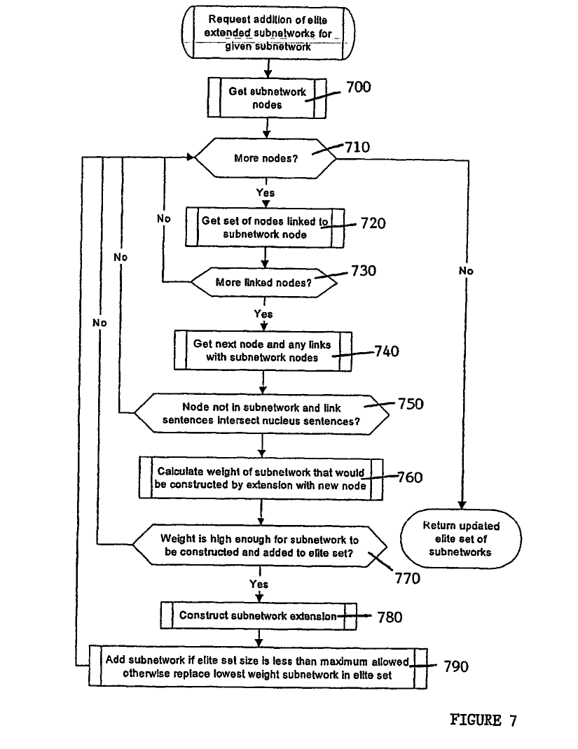

Referring to FIG. 7, the first step in requesting addition of elite extended sub-networks for a given sub-network is to get 700 the sub-network nodes. If there are more nodes 710, these set of nodes linked to sub-network node are retrieved 720. If there are more linked nodes 730, the next node is retrieved 740 and any links with sub-network nodes. If the node is not in the sub-network and link sentences intersect nucleus sentences 750, the weight is calculated 760 of the sub-network that would be constructed by extension with the new node. If the weight is high enough for sub-network to be constructed and added to elite set 770, the sub-network extension is constructed 780 and the sub-network is added 790 if the elite set size is less than the maximum allowed, otherwise the lowest weight sub-network in the elite set is replaced.

A search expression is generated from abstract discovery of the form:
nucleus & (word1|word2 . . . )

This yields sentences in which the nucleus is used with any of the words that were found in link relationships in the optimal sub-network.

The invention also provides phrase identification. Abstract document network phrase identification is a search for sequences of two or more non-stop words repeated in two or more sentences. Alternatively, the phrase identification could search for phrases repeated in a single sentence or multiple sentences.

Phrase identification uses the network layer of the abstract document network, in particular the node objects and link objects, to probe the document content at the word use level when a potential phrase sequence is considered. The search for phrases can be conducted at the abstract document network levels above the content plain text and without involving significant string comparisons.

Phrase identification is completed in a scan of the word use array with forward probing when a possible phrase sequence is found. A temporary word use mask array is used during the scan to eliminate redundant scanning as phrase uses ahead of the scan position are identified

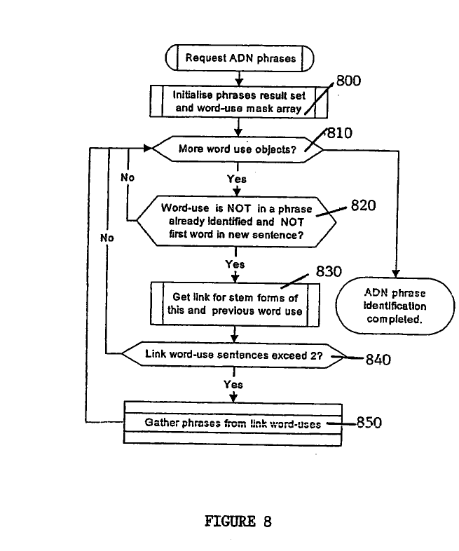

Referring to FIG. 8, the first step in requesting ADN phrases is to initialise 800 the phrases result set and word use mask array. If there are more word use objects 810 and the word use is not in a phrase already identified and not the first word in the new sentence 820, the link is obtained 830 for stem forms of this and previous word use. If the link word use sentences exceed 2 840, then the phrases are gathered 850 from link word uses.

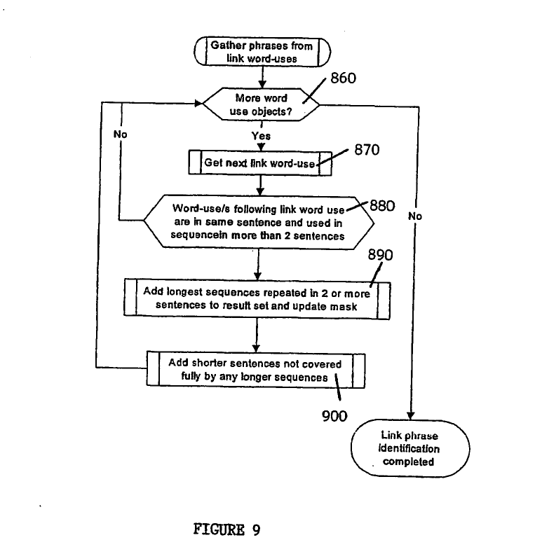

Referring to FIG. 9, the first step in gathering phrases from link word uses is to identify whether or not there are more word use objects 860 and if so, get 870 the next link word use if the word use(s) following link word use are in the same sentence and used in sequence in more than two sentences 880 the longest sequences repeated in two or more sentences are added 890 to the result set and the mask updated and shorter sequences are added 900 which are not covered fully by any longer sequences.

When the scanning of the word use array encounters a new pair of adjacent word uses in a sentence that have not been masked out, a new phrase has been identified if the corresponding link object is associated with a set of word uses in two or more sentences.

Further analysis of such linked words determines if the pair should be included in longer word sequences. The analysis surveys the set of word uses of the link for any stem forms that follow the initial sequence in more than one sentence. Any such words constitute part of a new ADN phrase. Extended sequences replace the shorter initial sequence if their distributions are subsumed within all those of its extended sequences. The longest possible extensions to the initial linked pair of words are considered by scanning from each of the initial word uses of the link pair possibly up to the end of each sentence if justified. This is determined from the distribution in the form of word uses of each intermediate sequence. When a phrase is finally identified, the word use mask array is updated to identify each use of the phrase.

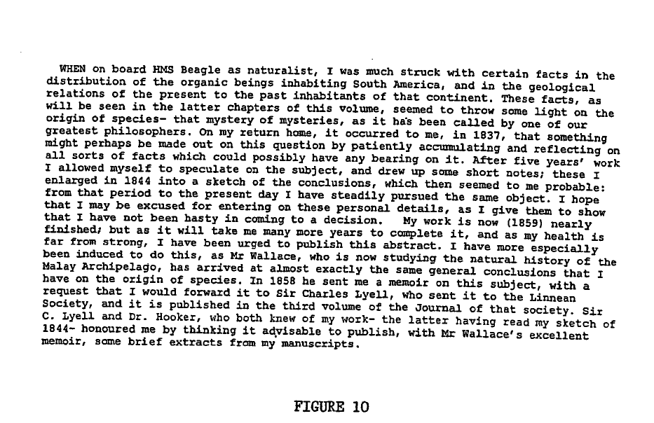

FIG. 10 illustrates an example content source text on which analysis can be performed. ADN construction first identifies sentences and words. Stem forms are mapped to nodes and any adjacent word uses in the same sentence are mapped to links between nodes.

The source text from FIG. 10 would be mapped into a set of nodes such as that shown in

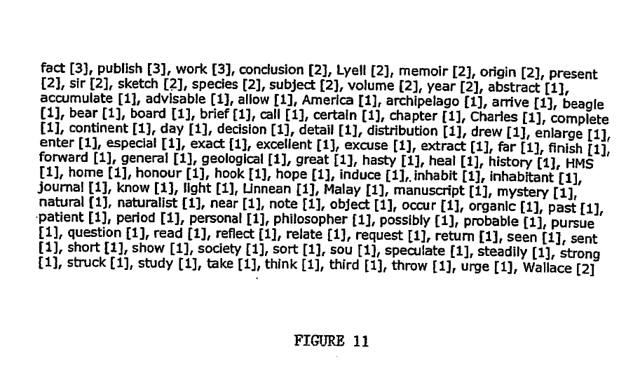

FIG. 11. Each node is associated with a stem form, a set of word uses and a weight being the number of sentences in which its word uses are found. Any of these nodes can be selected to perform abstract discovery around that node, or to extract the sentences in which associated word uses are found.

Abstract discovery beginning with the word “fact” finds the nodes with the highest sub-network weight within the specified limits of time and solutions that can be considered. This best sub-network is represented as a search expression:
fact & (sort|chapter|throw|volume|reflect|distribution|possibly|bear|species|accumulate|seen|origin|light|certain).

The above expression is used to extract cited sentences such as the following:
When on board HMS Beagle as naturalist, I was much struck with certain facts in the distribution of the organic beings inhabiting South America, and in the geological relations of the present to the past inhabitants of that continent.
These facts, as will be seen in the latter chapters of this volume, seem to throw some light on the origin of species—that mystery of mysteries, as it has been called by one of our greatest philosophers.
On my return home, it occurred to me, in 1837, that something might perhaps be made out on this question by patiently accumulating and reflecting on all sorts of facts which could possibly have any bearing on it.

As the source text of FIG. 10 is only a short section of a document, only one phrase is identified—“origin of species” found in two sentences as follows:
These facts, as will be seen in the latter chapters of this volume, seemed to throw some light on the origin of species—that mystery of mysteries, as it has been called by one of our greatest philosophers.
I have more especially been induced to do this, as Mr Wallace, who is now studying the natural history of the Malay Archipelago, has arrived at almost exactly the same general conclusions that I have on the origin of species.

The foregoing describes the invention including preferred forms thereof. Alterations and modifications as will be obvious to those skilled in the art are intended to be incorporated within the scope hereof, as defined by the accompanying claims.

1-15. (Canceled)

16. An electronic document indexing system comprising:
one or more word use nodes maintained in computer memory, each word use node representing a word in an electronic document and including a location of the word in the document; and
one or more node objects maintained in computer memory, the node object(s) respectively associated with one or more word use nodes.

17. An electronic document indexing system as claimed in claim 16 further comprising one or more link objects maintained in computer memory, each link object representing a pair of word use nodes.

18. An electronic document indexing system as claimed in claim 17 wherein the word use node(s) each include a word stem form.

19. An electronic document indexing system as claimed in claim 18 further comprising one or more word form nodes maintained in computer memory, each word form node representing a word in an electronic document.

20. An electronic document indexing system as claimed in claim 19 wherein each word node form node includes the word in the electronic document and the stem form of the word.

21. An electronic document indexing system as claimed in claim 16 wherein the node object(s) each include a word stem form.

22. An electronic document indexing system as claimed in claim 16 wherein the node object(s) each include a weight representing word frequency in the document.

23. An electronic document indexing system as claimed in claim 22 wherein the weight represents the number of sentences in which the word appears in the document.

24. An electronic document indexing system as claimed in claim 16 further comprising a sentence extractor configured to extract one or more sentences from the electronic document based on data retrieved from the electronic document indexing system.

25. An electronic document indexing system as claimed in claim 16 further comprising a word suggester configured to suggest one or more search terms to a user based on data retrieved from the electronic document indexing system.

26. An electronic document indexing system as claimed in claim 16 further comprising an abstract discoverer configured to compile data from the electronic document indexing system.

27. An electronic document indexing system as claimed in claim 16 further comprising a phrase identifier configured to extract one or more sentences from the electronic document based on data retrieved from the electronic document indexing system.

28. A method of creating an electronic document index comprising the steps of:
storing one or more word use nodes in computer memory, each word use node representing a word in an electronic document and indexing the location of the word in the document; and
storing one or more node objects in computer memory, the node object(s) respectively associated with one or more word use nodes.

29. A method of creating an electronic document index as claimed in claim 28 further comprising the step of storing one or more link objects in computer memory, each link object representing a pair of word use nodes.

30. A method of creating an electronic document index as claimed in claim 29 further comprising the step of storing one or more word form nodes in computer memory, each word form node representing a word in an electronic document.
